(19) United States
(12) Patent Application Publication
(10) Pub. No.: US 2014/0229595 A1
(43) Pub. Date: Aug. 14, 2014

(54) POLICY ASSERTION LINKING TO PROCESSING RULE CONTEXTS FOR POLICY ENFORCEMENT

(71) Applicant: INTERNATIONAL BUSINESS MACHINES CORPORATION, Armonk, NY (US)

(72) Inventors: Thomas C. Burke, Durham, NC (US); Mario E. De Armas, Wellington, FL (US); Oswaldo Gago, Margate, FL (US); Gaurang Shah, Cary, NC (US); Maria E. Smith, Davie, FL (US)

(73) Assignee: INTERNATIONAL BUSINESS MACHINES CORPORATION, Armonk, NY (US)

(21) Appl. No.: 13/764,864

(22) Filed: Feb. 12, 2013

(51) Int. Cl. H04L 12/24

(52) U.S. Cl. CPC H04L 41/5003
USPC 709/223

(57) ABSTRACT

A selectable policy enforcement mode of a policy enforcement point (PEP) is configured that, based upon a selected policy enforcement mode, selectively modifies an input message processing context. The selectively modified input message processing context is used to invoke policy enforcement rules from multiple policy domains to implement one of independent policy enforcement and sequential cascaded policy enforcement of the policy enforcement rules from the multiple policy domains. The selection of the policy enforcement mode is detected. The input message processing context used to invoke the policy enforcement rules is selectively modified based upon on the selected policy enforcement mode. The policy enforcement rules from the multiple policy domains are enforced during runtime based upon the selected policy enforcement mode and the modified input message processing context used to invoke the policy enforcement rules.

### RELATED APPLICATIONS

This application is related to the application titled “DYNAMIC GENERATION OF POLICY ENFORCEMENT RULES AND ACTIONS FROM POLICY ATTACHMENT SEMANTICS,” filed contemporaneously herewith on ______ and assigned application serial number ______, to the application titled “APPLYING POLICY ATTACHMENT SERVICE LEVEL MANAGEMENT (SLM) SEMANTICS WITHIN A PEERED POLICY ENFORCEMENT DEPLOYMENT,” filed contemporaneously herewith on ______ and assigned application serial number ______, and to the application titled “INSTRUMENTATION AND MONITORING OF SERVICE LEVEL AGREEMENT (SLA) AND SERVICE POLICY ENFORCEMENT,” filed contemporaneously herewith on ______ and assigned application serial number ______, each of which is hereby incorporated by reference as if fully set forth herein.

### BACKGROUND

The present invention relates to service level agreement (SLA) policy enforcement. More particularly, the present invention relates to policy assertion linking to processing rule contexts for policy enforcement.

Service level agreements (SLAs) are contracts for services formed between consumers and service providers. For example, a consumer may enter into a service level agreement with a service provider to send and/or receive an agreed number of messages (e.g., text messages) per month for a contracted/set fee. The SLA may further specify that if the consumer exceeds the agreed number of messages per month associated with the contracted/set fee, an additional per message fee will be charged for each additional message.

### BRIEF SUMMARY

A method includes: configuring, via a processor, a selectable policy enforcement mode of a policy enforcement point (PEP) that, based upon a selected policy enforcement mode, selectively modifies an input message processing context used to invoke policy enforcement rules from multiple policy domains to implement one of independent policy enforcement and sequential cascaded policy enforcement of the policy enforcement rules from the multiple policy domains; detecting the selection of the policy enforcement mode; selectively modifying the input message processing context used to invoke the policy enforcement rules based upon on the selected policy enforcement mode; and enforcing the policy enforcement rules from the multiple policy domains during runtime based upon the selected policy enforcement mode and the modified input message processing context used to invoke the policy enforcement rules.

A system includes a memory and a processor programmed to: configure, within the memory, a selectable policy enforcement mode of a policy enforcement point (PEP) that, based upon a selected policy enforcement mode, selectively modifies an input message processing context used to invoke policy enforcement rules from multiple policy domains to implement one of independent policy enforcement and sequential cascaded policy enforcement of the policy enforcement rules from the multiple policy domains; detect the selection of the policy enforcement mode; selectively modify the input message processing context used to invoke the policy enforcement rules based upon on the selected policy enforcement mode; and enforce the policy enforcement rules from the multiple policy domains during runtime based upon the selected policy enforcement mode and the modified input message processing context used to invoke the policy enforcement rules.

A computer program product includes a computer readable storage medium having computer readable program code embodied therewith, where the computer readable program code when executed on a computer causes the computer to: configure a selectable policy enforcement mode of a policy enforcement point (PEP) that, based upon a selected policy enforcement mode, selectively modifies an input message processing context used to invoke policy enforcement rules from multiple policy domains to implement one of independent policy enforcement and sequential cascaded policy enforcement of the policy enforcement rules from the multiple policy domains; detect the selection of the policy enforcement mode; selectively modify the input message processing context used to invoke the policy enforcement rules based upon on the selected policy enforcement mode; and enforce the policy enforcement rules from the multiple policy domains during runtime based upon the selected policy enforcement mode and the modified input message processing context used to invoke the policy enforcement rules.

### BRIEF DESCRIPTION OF THE SEVERAL VIEWS OF THE DRAWINGS

FIG. 1 is a block diagram of an example of an implementation of a system for policy assertion linking to processing rule contexts for policy enforcement according to an embodiment of the present subject matter;

FIG. 2 is a block diagram of an example of an implementation of a core processing module capable of performing policy assertion linking to processing rule contexts for policy enforcement according to an embodiment of the present subject matter;

FIG. 3 is a diagram of an example of an implementation of a filter-mode policy enforcement flow for policy assertion linking to processing rule contexts for policy enforcement using a “filter” enforcement mode of operation according to an embodiment of the present subject matter;

FIG. 4 is a diagram of an example of an implementation of an enforce-mode policy enforcement flow for policy assertion linking to processing rule contexts for policy enforcement using an “enforce” enforcement mode of operation according to an embodiment of the present subject matter;

FIG. 5 is a flow chart of an example of an implementation of a process for policy assertion linking to processing rule contexts for policy enforcement according to an embodiment of the present subject matter; and

FIG. 6 is a flow chart of an example of an implementation of a process for policy assertion linking to processing rule contexts for policy enforcement according to an embodiment of the present subject matter.

### DETAILED DESCRIPTION

The examples set forth below represent the necessary information to enable those skilled in the art to practice the invention and illustrate the best mode of practicing the invention. Upon reading the following description in light of the accompanying drawing figures, those skilled in the art will understand the concepts of the invention and will recognize applications of these concepts not particularly addressed herein. It should be understood that these concepts and applications fall within the scope of the disclosure and the accompanying claims.

The subject matter described herein provides policy assertion linking to processing rule contexts for policy enforcement. The present technology utilizes multiple policy domains (e.g., Websphere® compliant policy domains) at a single service/attachment point on a policy enforcement point (PEP). A selectable policy enforcement mode is configured within a policy enforcement point (PEP) that, based upon the selected policy enforcement mode, selectively modifies an input message processing context used to invoke policy enforcement rules from the multiple policy domains. The selectable policy enforcement mode implements one of independent policy enforcement and sequential cascaded policy enforcement of the policy enforcement rules from the multiple policy domains. A selection of a policy enforcement mode is detected and the input processing context used to invoke the policy enforcement rules is selectively modified based upon on the selected policy enforcement mode. The policy enforcement rules from the multiple policy domains are enforced during runtime based upon the selected policy enforcement mode and the modified input processing context used to invoke the policy enforcement rules.

The policy enforcement rules include processing rules and processing actions that are linked as described herein to original registry policy assertions. The policy enforcement rules are used to enforce the original registry policy assertions during runtime. As such, for purposes of the present description, the processing actions may alternatively be referred to as “policy assertions.”

To implement the present technology, a processing mechanism within a policy mapping framework provides one or more input request/message processing contexts that may be shared by policy alternatives (e.g., processing rules and processing actions) based upon the policy enforcement mode selection to allow an output of one assertion to be selectively consumed by a subsequent assertion/action. Alternatively, each policy alternative may utilize the shared request/message processing contexts unmodified by other policy alternatives based upon the policy enforcement mode selection.

An “enforce” policy enforcement mode selection and a “filter” policy enforcement mode selection each configure SLA processing and modify the respective message context sharing utilization by the respective policy assertions. Within the enforce mode of processing, certain processing modules of the PEP operate sequentially and the output of one assertion is provided to the next processing module as input. Within the filter mode of processing, each processing module of the PEP independently receives the shared message context (e.g., unmodified by previous processing modules) and performs its respective processing based upon the original input object context. The present technology manages the input context for the invocation for each SLA rule based upon the enforcement mode that has been selected.

Based upon the present subject matter, a selectable policy enforcement mode may be implemented and a policy enforcement mode selected to allow more than one output-altering policy assertion to be used in the same policy alternative. Further, policy assertions may be rendered in the order that they appear in a policy, thereby providing a policy author with an opportunity to create more sophisticated/robust policy expressions. Additionally, output of one SLA policy rendering may optionally be passed along to a subsequent SLA policy rendering, again based upon an “enforce” SLA processing mode selection.

The following example of a policy specification is provided that utilizes multiple policy domains. It should be noted that policy specifications may be utilized to describe a framework and attachment semantics for enforcing a policy for web services. Further, policy specifications, such as WS-Security and WS-ReliableMessaging, represent policy domain specifications that are authored to adhere to a WS-Policy standard. The specification of a policy domain is a contract describing the interface and behavior of the policy domain.

To continue with the present example, is will be assumed that a policy author wants to use two custom policy domains within the same registry policy. One of the custom policies is from a company that specializes in message validation, and another of the custom policies is from a company that specializes in message transformation.

The following first pseudo policy identifier represents the first custom policy from the company specializing in message validation.

xmlns:cv=“/2011/03/cartValidation”

The following second pseudo policy identifier represents the first custom policy from the company specializing in message transformation.

xmlns:ct=“/2011/03/cartTransform”

A PEP that is operating based upon the present technology may enforce such a policy that contains assertions from both of the policy domains as represented below within the following policy pseudo syntax excerpt.

<wsp:ExactlyOne>
<wsp:All>
<!-- policy author's note: validate the incoming message to ensure customer's cart selection is
valid per the Version 1 format, then transform it to the new Version2 cart format, validate the
result, and sign it to express its authenticity before it goes to the back-end for processing.-->
<cv:Validate format=“V1ShoppingCart”/>
<cv:Transform input=“VlSchema” input=“V2Schema”/>
<cv:Validate format=“V2ShoppingCart”/>
<sp:SignedParts><sp:Body/></sp:SignedParts>
</wsp:All>
</wsp:ExactlyOne>

As described above, the present technology provides a mechanism for passing the output of one assertion to the next assertion to be enforced. This may be performed by defining shared input and output message processing contexts that may be selectively used by all policy assertions in a policy alternative. A mechanism is also provided for each policy implementation to determine the name of the shared contexts to be used by the respective implementations so that the policy mapping framework may ensure that assertions are chained as designated by the policy author.

To implement shared context processing, shared input and output message contexts are defined and named. The shared context names are written to an environment variable or otherwise published to be accessible to the respective policy assertions. The shared input contexts are initialized with a pre-defined “INPUT” context. Assertions are rendered and each assertion writes to a shared output even if the processing of the assertion performs an identity transform from the shared input. The shared output context is then copied/written to an “OUTPUT” context.

It should be noted that the input and output contexts are specified by the policy mapping framework. As such, the shared input context ensures appropriate chaining of policy assertions. For example, if a first assertion uses “SHARED_IN” as its input context and then writes its output to the same context, then a second assertion may use the “SHARED_IN” input context as its input for processing, and this may continue across assertions that are sequentially processed. However, such an implementation may limit the flexibility of rendering each assertion on separate processing rules.

The present technology leverages automated policy transformation and runtime enforcement that allows policies within a policy domain (e.g., service provider policy domain, etc.) to be associated with any runtime object (e.g., objects representing specific consumers, organizations, service resources, etc.) that needs to be controlled or regulated by that policy. Those policies may be enforced against the runtime object(s) at policy enforcement points (PEPs) that operate to provide proxy service offerings including policy enforcement. Examples of runtime objects against which policies may be enforced include transactions, web requests, database requests, representational state transfer (REST) services, and web applications. The control or regulation of the runtime object by a policy may be further determined based upon the content of that object at runtime, such as user credentials. Policies may be attached at an object level for an object, thereby enhancing the specificity of policy enforcement based upon the granularity of the respective objects (e.g., at the level of specific consumers, organizations, service resources, etc.) and based upon the content of those objects at runtime.

The present technology may be applied, for example, to implement service level agreements (SLAs) within a service oriented architecture (SOA) network appliance engine. The present technology may be implemented, for example, using higher-level gateway platform actions rather than low-level code. As such, implementation may be performed at a layer of abstraction above the encoding level for the respective appliance engines. It should be noted that the present technology may be implemented with a variety of policy constructs and is not limited to particular variations of how policies are constructed. Accordingly, the present technology may be flexibly applied across a variety of service platforms.

It should be noted that conception of the present subject matter resulted from recognition of certain limitations associated with policy administration and enforcement. For example, it was observed that a service level agreement (SLA) policy may specify policy assertions that may alter an incoming request/message from different policy domains. Further, it was observed that SLA policies themselves are autonomous and may run without knowledge of other policies. It was further observed that the enforcement of the policies themselves may also vary from one request/message to another if the credentials (e.g., user identifier) are different. Additionally, it was observed that while the specification of a policy domain is a contract describing the interface and behavior of the policy domain, implementation of a policy domain is specific to the PEP used to enforce the policy. It was additionally observed that enforcement is the responsibility of the PEP to ensure the interoperability of all of the supported policy domains, and to provide a mechanism for custom policy domains to participate in this interoperability. It was further observed that policy specifications, such as WS-Policy, do not define an interoperability mechanism for policy assertions, and no de-facto standard exists today to ensure interoperability of policy assertions from different policy domains. It was additionally determined that such specifications provide no guarantee of the ordering of assertion execution and that, as such, there is no mechanism within previous systems by which to ensure that policy assertions are rendered in the order that they appear in a policy developed by a policy administrator. It was additionally observed that SLA policies create their own processing rules and processing actions independently of other SLAs, including policies attached at the same policy subject. In view of these observations, it was determined that a mechanism to solve these challenges of interoperability of policy assertions may be implemented by providing and managing selectable/flexible policy enforcement modes for input context SLA processing, as described herein. As such, in view of the observations and determinations described above, the present subject matter improves policy enforcement by providing for policy assertion linking to processing rule contexts for policy enforcement, as described above and in more detail below.

Several additional definitions may be utilized within the following description, and some are repeated and further defined below. The term “service policy” or “policy” as utilized herein represents any mediation enforcement provision, routing provision, security provision, or any other custom policy/provision that is written to a specification that a policy enforcement system may implement. As such, a service policy may be implemented as a web service (e.g., web services description language (WSDL)), as a representational state transfer (REST) implementation or service, as a web application (e.g., plain old XML (PDX)) implementation, as a database request, or otherwise as appropriate for the given implementation.

Regarding service policies, a service level agreement (SLA) is a service policy that represents an agreement (e.g., a contract for services) between a service provider and a consumer where a level of service is formally defined and agreed between the parties to the SLA. The SLA records a common understanding about services, priorities, responsibilities, guarantees, warranties, and any other particulars of the agreement. Examples of SLAs include business services such as a web service, a REST service, and a web application. The SLA may specify, for example, the levels of availability, serviceability, performance, operation, or other attributes of the service to be provided by the service provider to the consumer. As a further example, an SLA may represent a processing agreement such as a transaction rate, a processor utilization level, a disk utilization level, and a memory utilization level for the business service.

A service level definition (SLD) represents a service policy that protects the service provider infrastructure access and utilization constraints, such as for example from accesses by non-contracting entities for which an SLA has not been established, or to limit a maximum resource utilization to prevent service degradation (e.g., maximum number of messages per minute). An SLD, when attached to a policy subject, is enforced by a policy enforcement point (PEP). A “policy subject” represents an entity with which a policy (e.g., an SLA or SLD) may be associated, such as for example, an endpoint of a transaction, a message, a resource, an operation, or other entity.

A policy administration point (PAP) represents a location (e.g., repository, registry, etc.) where policies such as SLAs and SLDs may be created, stored, accessed, and modified. A WebSphere® service registry and repository (WSRR) represents one possible example of a PAP. A policy enforcement point (PEP) represents an intermediary system that operates to enforce defined policies. The PEP provides proxy service offerings including policy enforcement. A “policy framework” represents the infrastructure used to convert supported policy vocabularies into processing actions and processing rules.

A policy may be specified as an SLA between a service provider and a consumer. Each consumer may have its own selected service options. As such, for purposes of the present example, it is assumed that two consumers have selected different service plans for a particular service. Within this example, one consumer has selected a “default” service level defined within the service provider domain for this particular service offering at a level of one hundred (100) allowed requests per hour. Similarly, another consumer has selected a higher-tier service level, identified within the present example as a “gold” service level, with a service offering of five hundred (500) allowed requests per hour. As such, enforcement of this SLA by a PEP would involve identification of the respective consumers, correlation of the respective consumers with their selected service plans/levels, and monitoring of request rates (e.g., message rates, transaction rates, etc.) for each consumer based upon their respective selected plans. If a threshold number of requests per hour associated with a selected plan were reached, the PEP would then invoke processing to identify any additional service requests as overages relative to the plan or prevent the service requests, as appropriate for a given implementation. Similarly, if a consumer issues a request that is authorized based upon the selected service plan, the PEP is responsible for ensuring that the request is satisfied for the consumer by the service provider.

The present technology enhances policy enforcement point (PEP) functionality to link policy assertions to processing rule contexts for policy enforcement. Processing rule contexts are created and may be shared or independently consumed by the processing rules and processing actions. The policy enforcement rules and actions are dynamically implemented and enforced on a transactional basis during runtime as transactions associated with the defined policies occur (e.g., as messages are received).

Example transformations include transformation of a defined service policy into one or more processing actions in a normalized and interchangeable format. The normalized and interchangeable format may include, for example, a language such as extensible markup language (XML), XML stylesheet language for transformations (XSLT), object-oriented languages such as Java™ and C++ programming languages, relational database management (RDBM) languages such as structured query language (SQL), and scripting languages/implementations such as PHP: Hypertext Preprocessor (PHP) and Perl.

It should be noted that the PEP processing technology described herein operates as a proxy for both the service providers and the consumers to enforce the various provisions of defined SLAs and SLDs. As such, the PEP represents a proxy component/entity for both the service provider(s) and for the consumer(s). Within this proxy context for policy enforcement, the PEP operates to protect the interests of the service providers to ensure that no unauthorized consumers access the respective services provided by the service providers and to ensure that consumers that are authorized do not exceed the defined SLDs associated with the services and service providers. Similarly, the PEP operates to protect the interests of consumers and service providers to ensure that the SLA(s) for which the consumers and service providers have contracted are upheld/enforced. To fulfill this dual-proxy role, the PEP operates as a proxy intermediary for both of the respective entities to analyze messages communicated between the respective entities and to enforce policy enforcement rules that are defined in association with the PEP based upon policies associated with the respective services and agreements.

A policy framework, as described in more detail below, consumes policies for enforcement by a PEP. To enforce the respective policies, the policy framework generates policy enforcement rules that include processing actions. The policy framework creates processing rule contexts, and distributes those processing rule contexts for consumption by processing rules and processing actions. A policy mapping framework within the policy framework may perform the policy assertion linking to processing rule contexts for policy enforcement described herein.

The policy assertion linking to processing rule contexts for policy enforcement described herein may be performed in real time to allow prompt policy enforcement within a runtime environment. For purposes of the present description, real time shall include any time frame of sufficiently short duration as to provide reasonable response time for information processing acceptable to a user of the subject matter described. Additionally, the term “real time” shall include what is commonly termed “near real time”—generally meaning any time frame of sufficiently short duration as to provide reasonable response time for on-demand information processing acceptable to a user of the subject matter described (e.g., within a portion of a second or within a few seconds). These terms, while difficult to precisely define are well understood by those skilled in the art.

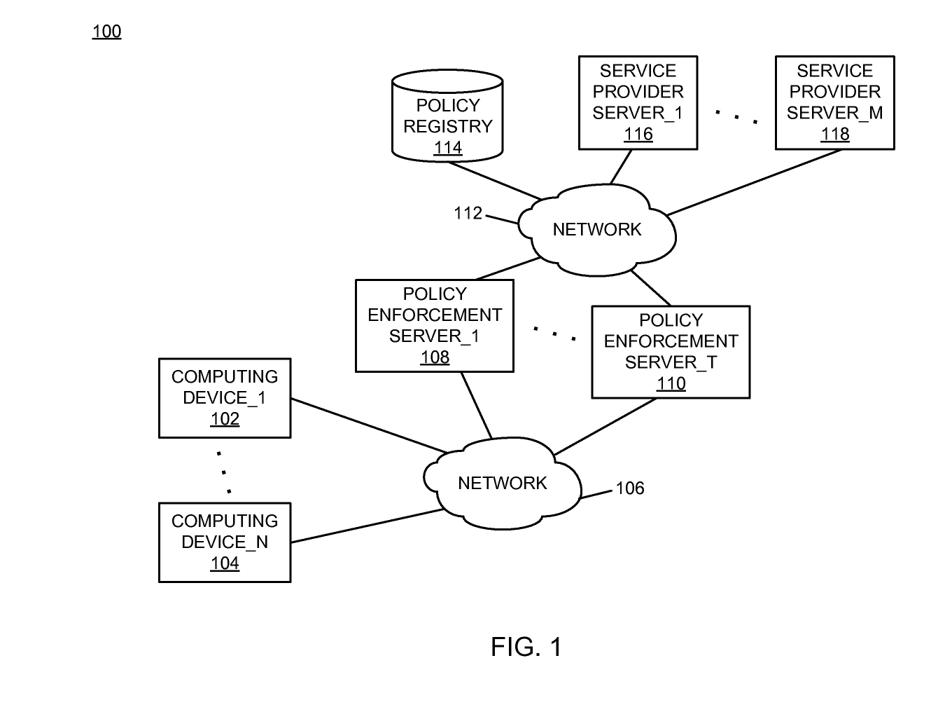

FIG. 1 is a block diagram of an example of an implementation of a system 100 for policy assertion linking to processing rule contexts for policy enforcement. A computing device_{—}1 102 through a computing device_N 104 represent consumer client devices that utilize services specified by SLAs. The computing device_{—}1 102 through the computing device_N 104 may communicate with one another and with other devices via a network 106. A policy enforcement server_{—}1 108 through a policy enforcement server_T 110 represent policy enforcement points (PEPs), as described above. The policy enforcement server_{—}1 108 through the policy enforcement server_T 110 communicate and interconnect via a network 112 with a policy registry 114 that stores policies (e.g., SLDs and SLAs) generated by one or more of a service provider server_{—}1 116 through a service provider server_M 118. It should be noted that the network 106 and the network 112 are illustrated as separate networks for ease of description, and that any arrangement of interconnection may be utilized as appropriate for a given implementation.

The service provider server_{—}1 116 through the service provider server_M 118 represent service capable devices (e.g., messaging devices for text messages, etc.). The service provider server_{—}1 116 through the service provider server_M 118 also represent administrative devices that may be utilized by service provider administrators for policy creation, such as creation of SLDs and SLAs.

As described above, policies implemented by service provider administrators via devices, such as the service provider server_{—}1 116 through the service provider server_M 118, may be stored within the policy registry 114 for enforcement by PEPs, such as the policy enforcement server_{—}1 108 through the policy enforcement server_T 110. The policy enforcement server_{—}1 108 through the policy enforcement server_T 110 each implement a policy framework as described above and in more detail below for transformation and enforcement of defined service policies stored in the policy registry 114 into policy enforcement rules that include processing rules and processing actions that are to be enforced during runtime against objects. The objects may be of varying granularity (e.g., at the level of specific consumers, organizations, service resources, etc., as described above) based upon the particular scope and configuration of the respective policies to be enforced for the respective service providers and consumers.

A PEP may be implemented via each of the policy enforcement server_{—}1 108 through the policy enforcement server_T 110. The PEP has the role of enforcing policies defined outside or within the PEP. The PEPs operate as gateways that provide virtual services that proxy policy enforcement operations for the real backend services. The PEPs protect and optimize transactions flowing through the respective network(s) on behalf of the backend services. The PEPs may utilize rule processing contexts to enforce policies from multiple policy domains. As such, the policy enforcement server_{—}1 108 through the policy enforcement server_T 110 each represent proxy gateways that provide proxy services for the service providers represented by the service provider server_{—}1 116 through the service provider server_M 118 and for consumers represented by the computing device_{—}1 102 through the computing device_N 104.

It should be noted that there may be a many-to-one relationship of PEPs to service providers. Each PEP may create its own policy enforcement rules based upon policies to be enforced for a given service provider. By use of the present technology, the policy enforcement rule creation from defined policies may be consistently repeated across the set of PEPs that are designated to enforce the respective policies.

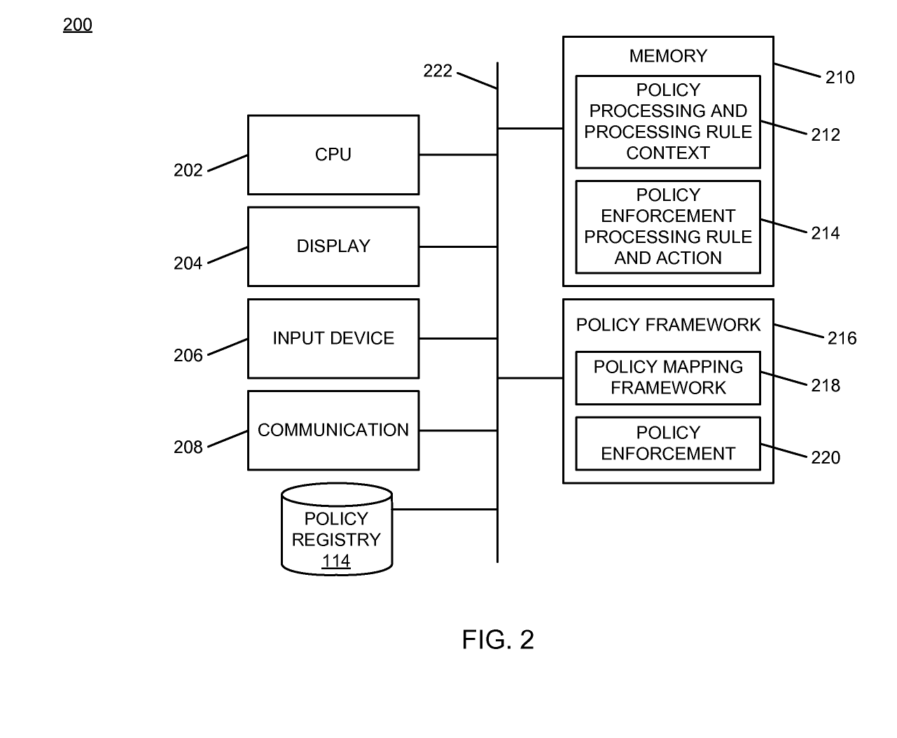

As will be described in more detail below in association with FIG. 2 through FIG. 6, the policy enforcement server_{—}1 108 through the policy enforcement server_T 110 may each provide automated policy assertion linking to processing rule contexts for policy enforcement. The automated policy assertion linking to processing rule contexts for policy enforcement is based upon creation of rule processing contexts that may be utilized to enforce policies from multiple policy domains during runtime to fulfill the respective SLDs and SLAs established for messaging management within the system 100. A variety of possibilities exist for implementation of the present subject matter, and all such possibilities are considered within the scope of the present subject matter.

It should be noted that any of the respective computing devices described in association with FIG. 1 may be portable computing devices, either by a user's ability to move the respective computing devices to different locations, or by the respective computing device's association with a portable platform, such as a plane, train, automobile, or other moving vehicle. It should also be noted that the respective computing devices may be any computing devices capable of processing information as described above and in more detail below. For example, the respective computing devices may include devices such as a personal computer (e.g., desktop, laptop, etc.) or a handheld device (e.g., cellular telephone, personal digital assistant (PDA), email device, music recording or playback device, tablet computing device, e-book reading device, etc.), a service provider messaging server, a web server, application server, or other data server device, or any other device capable of processing information as described above and in more detail below.

The network 106 and the network 112 may include any form of interconnection suitable for the intended purpose, including a private or public network such as an intranet or the Internet, respectively, direct inter-module interconnection, dial-up, wireless, or any other interconnection mechanism capable of interconnecting the respective devices.

FIG. 2 is a block diagram of an example of an implementation of a core processing module 200 capable of performing policy assertion linking to processing rule contexts for policy enforcement. The core processing module 200 may be associated with either the policy enforcement server_{—}1 108 through the policy enforcement server_T 110 to implement the policy assertion linking to processing rule contexts for policy enforcement described herein. It should, however, be noted that components of the core processing module 200 may additionally or alternatively be associated with the computing device_{—}1 102 through the computing device_N 104 or with the service provider server_{—}1 116 through the service provider server_M 118, as appropriate for a given implementation. As such, the core processing module 200 is described generally herein, though it is understood that many variations on implementation of the components within the core processing module 200 are possible and all such variations are within the scope of the present subject matter.

Further, the core processing module 200 may provide different and complementary processing of policy assertion linking to processing rule contexts for policy enforcement via the created policy enforcement rules in association with each implementation. As such, for any of the examples below, it is understood that any aspect of functionality described with respect to any one device that is described in conjunction with another device (e.g., sends/sending, etc.) is to be understood to concurrently describe the functionality of the other respective device (e.g., receives/receiving, etc.).

A central processing unit (CPU) 202 provides computer instruction execution, computation, and other capabilities within the core processing module 200. A display 204 provides visual information to a user of the core processing module 200 and an input device 206 provides input capabilities for the user.

The display 204 may include any display device, such as a cathode ray tube (CRT), liquid crystal display (LCD), light emitting diode (LED), electronic ink displays, projection, touchscreen, or other display element or panel. The input device 206 may include a computer keyboard, a keypad, a mouse, a pen, a joystick, touchscreen, or any other type of input device by which the user may interact with and respond to information on the display 204.

It should be noted that the display 204 and the input device 206 may be optional components for the core processing module 200 for certain implementations/devices. Accordingly, the core processing module 200 may operate as a completely automated embedded device without direct user configurability or feedback. However, the core processing module 200 may also provide user feedback and configurability via the display 204 and the input device 206, respectively, as appropriate for a given implementation.

A communication module 208 provides interconnection capabilities that allow the core processing module 200 to communicate with other modules within the system 100. The communication module 208 may include any electrical, protocol, and protocol conversion capabilities useable to provide interconnection capabilities, appropriate for a given implementation.

A memory 210 includes a policy processing and processing rule context storage area 212 that provides memory space for the creation and storage of policies (e.g., SLAs and SLDs) in association with the core processing module 200 when implemented, for example, in association with one or more of the service provider server_{—}1 116 through the service provider server_M 118. Additionally, the policy processing and processing rule context storage area 212 provides memory space for the creation of processing rule contexts that may be shared among processing rules and processing actions to support the runtime enforcement of defined policies (e.g., SLAs and SLDs) from different policy domains in association with the core processing module 200 when implemented, for example, in association with one or more of the policy enforcement server_{—}1 108 through the policy enforcement server_T 110.

The memory 210 also includes a policy enforcement processing rule and action storage area 214 that provides storage space for created policy enforcement rules and associated runtime processing actions. As described above, the created policy enforcement rules and associated runtime processing actions may be utilized for runtime enforcement of defined policies (e.g., SLAs and SLDs) in association with the core processing module 200 when implemented, for example, in association with one or more of the policy enforcement server_{—}1 108 through the policy enforcement server_T 110. The processing rules and processing actions may utilize the processing rule contexts to enforce policies from different policy domains.

It is understood that the memory 210 may include any combination of volatile and non-volatile memory suitable for the intended purpose, distributed or localized as appropriate, and may include other memory segments not illustrated within the present example for ease of illustration purposes. For example, the memory 210 may include a code storage area, an operating system storage area, a code execution area, and a data area without departure from the scope of the present subject matter.

A policy framework module 216 is also illustrated. The policy framework module 216 provides processing rule context management for policy enforcement for the core processing module 200, as described above and in more detail below. The policy framework module 216 implements the policy assertion linking to processing rule contexts for policy enforcement of the core processing module 200.

The policy framework module 216 includes a policy mapping framework module 218 that manages the creation of processing rule contexts and chaining of assertions for SLDs and SLAs that are enforced during runtime processing of objects. A policy enforcement module 220 implements and manages policy enforcement rules and runtime processing actions created from the original policy definitions, and processes objects using assertions as chained by the policy mapping framework module 218.

It should also be noted that the policy framework module 216 may form a portion of other circuitry described without departure from the scope of the present subject matter. Further, the policy framework module 216 may alternatively be implemented as an application stored within the memory 210. In such an implementation, the policy framework module 216 may include instructions executed by the CPU 202 for performing the functionality described herein. The CPU 202 may execute these instructions to provide the processing capabilities described above and in more detail below for the core processing module 200. The policy framework module 216 may form a portion of an interrupt service routine (ISR), a portion of an operating system, a portion of a browser application, or a portion of a separate application without departure from the scope of the present subject matter.

The policy registry 114 is also shown associated with the core processing module 200 within FIG. 2 to show that the policy registry 114 may be coupled to the core processing module 200 without requiring external connectivity, such as via the network 106 or the network 112.

The CPU 202, the display 204, the input device 206, the communication module 208, the memory 210, the policy framework module 216, and the policy registry 114 are interconnected via an interconnection 222. The interconnection 222 may include a system bus, a network, or any other interconnection capable of providing the respective components with suitable interconnection for the respective purpose.

Though the different modules illustrated within FIG. 2 are illustrated as component-level modules for ease of illustration and description purposes, it should be noted that these modules may include any hardware, programmed processor(s), and memory used to carry out the functions of the respective modules as described above and in more detail below. For example, the modules may include additional controller circuitry in the form of application specific integrated circuits (ASICs), processors, antennas, and/or discrete integrated circuits and components for performing communication and electrical control activities associated with the respective modules. Additionally, the modules may include interrupt-level, stack-level, and application-level modules as appropriate. Furthermore, the modules may include any memory components used for storage, execution, and data processing for performing processing activities associated with the respective modules. The modules may also form a portion of other circuitry described or may be combined without departure from the scope of the present subject matter.

Additionally, while the core processing module 200 is illustrated with and has certain components described, other modules and components may be associated with the core processing module 200 without departure from the scope of the present subject matter. Additionally, it should be noted that, while the core processing module 200 is described as a single device for ease of illustration purposes, the components within the core processing module 200 may be co-located or distributed and interconnected via a network without departure from the scope of the present subject matter. For a distributed arrangement, the display 204 and the input device 206 may be located at a point of sale device, kiosk, or other location, while the CPU 202 and memory 210 may be located at a local or remote server. Many other possible arrangements for components of the core processing module 200 are possible and all are considered within the scope of the present subject matter. It should also be understood that, though the policy registry 114 is illustrated as a separate component for purposes of example, the information stored within the policy registry 114 may also/alternatively be stored within the memory 210 without departure from the scope of the present subject matter. Accordingly, the core processing module 200 may take many forms and may be associated with many platforms.

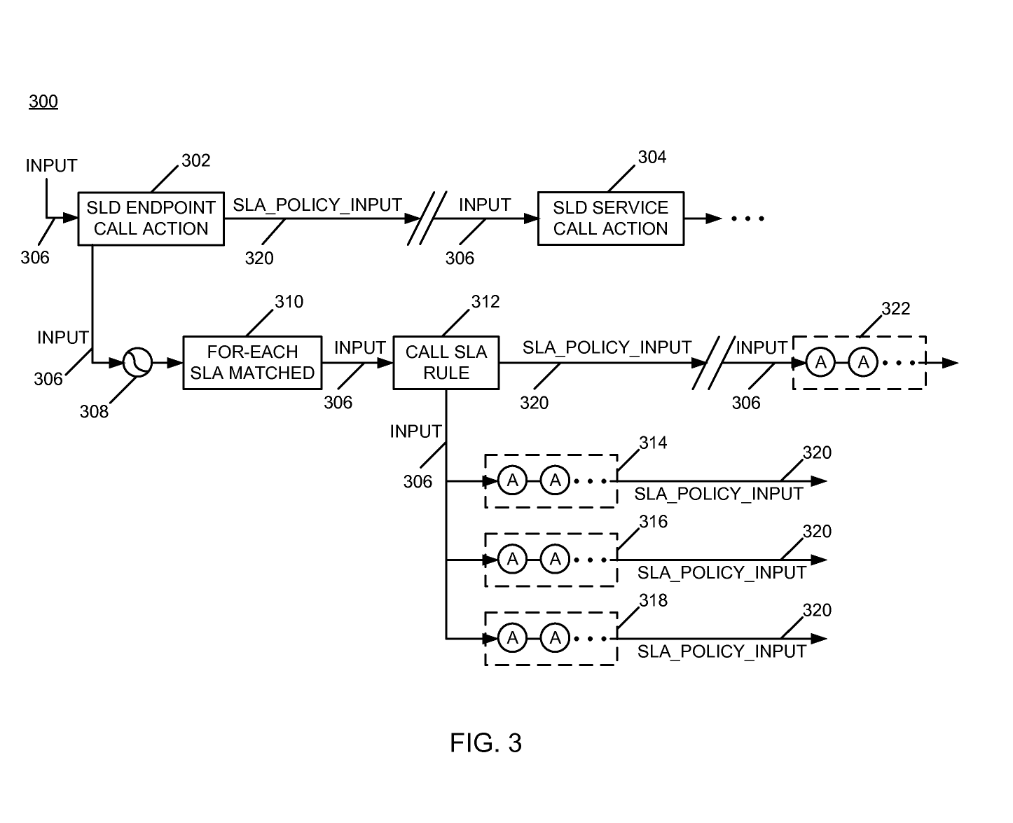

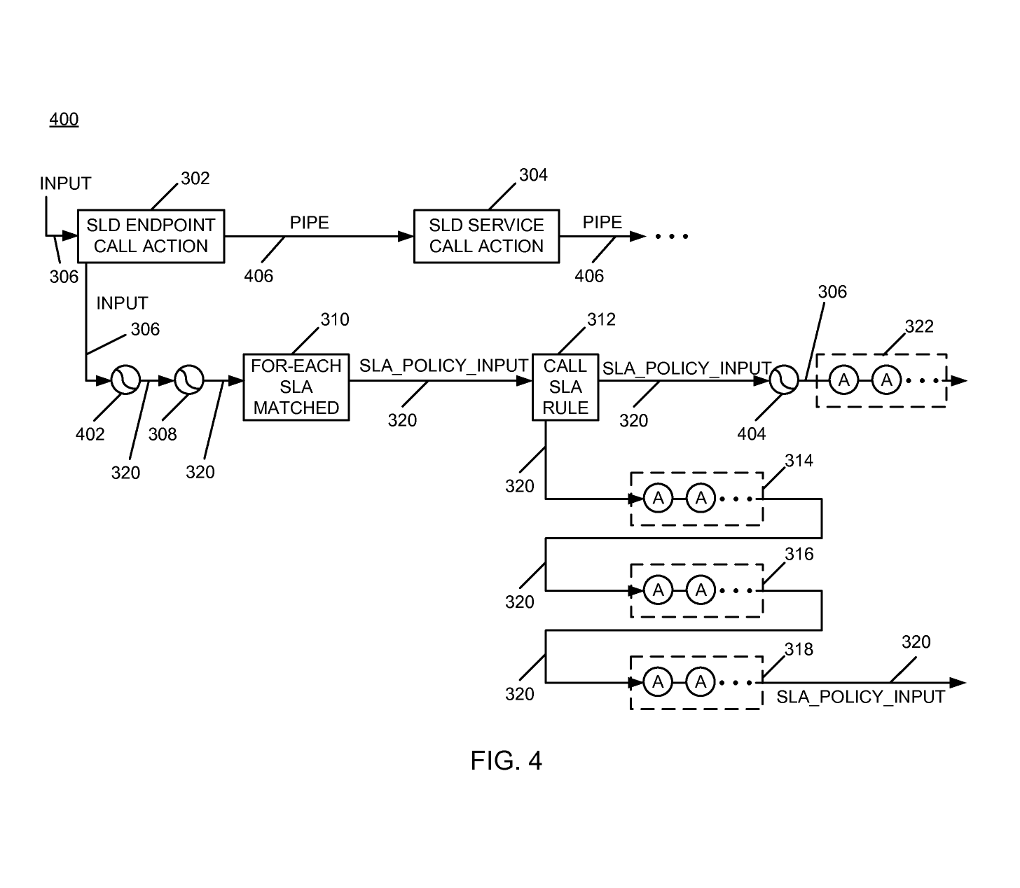

FIG. 3 through FIG. 4 described below represent example processing flows for policy assertion linking to processing rule contexts for policy enforcement. The example processing flows may be performed by the policy framework 216. The example policy assertion linking to processing rule contexts for policy enforcement represented within FIG. 3 through FIG. 4 are described for purposes of example. However, it should be noted that many possibilities exist for policy assertion linking to processing rule contexts for policy enforcement in association with one or more PEPs, and all such possibilities are considered within the scope of the present technology.

FIG. 3 is a diagram of an example of an implementation of a filter-mode policy enforcement flow 300 for policy assertion linking to processing rule contexts for policy enforcement using a “filter” enforcement mode of operation. For purposes of the present examples, it is assumed that SLA enforcement precedes SLD enforcement against objects (e.g., messages). As such, and as can be seen from FIG. 3, several processing assertions associated with policies to be enforced are represented. An SLD endpoint call action 302 for SLA policy enforcement is shown to precede an SLD service call action 304 for SLD policy enforcement.

With the enforcement mode set to “filter,” any changes made to a message in the flow are not reflected in or considered by subsequent processing rules. As such an “INPUT” processing rule context 306 is provided unmodified as input to each processing rule and processing action, as can be seen distributed to all processing actions represented within FIG. 3.

Regarding SLA processing, an SLA-check action 308 matches SLA processing rules based upon runtime contents of messages (e.g., user credentials/identifiers) to determine which SLA processing rules are to be selected to process the respective message. As such, the SLA-check action may be considered a transformation that identifies matching SLAs. A for-each SLA matched action 310 invokes a call SLA rule action 312 to call each matching SLA processing rule and passes the INPUT processing rule context 306 as the input to all the subsequent SLA processing rules. Within the present example, three matching SLA processing rules are assumed to have been identified and invoked to process the message: an SLA processing rule 314, an SLA processing rule 316, and an SLA processing rule 318. Each of the matching SLA processing rules 314 through 318 include processing actions represented by the circled letter “A” within each SLA processing rule that is processed.

The SLA rules themselves store their respective outputs into an SLA_POLICY_INPUT context 320. However, any subsequent SLA processing rule will still use the INPUT processing rule context 306 as its input context. As such, any changes made to the message during processing by the respective processing rules would not be passed along or consumed by subsequent processing rules. Additionally, after the matching SLA processing rules 314 through 318 have completed their respective processing actions on the message, the policy framework 216 ignores the SLA_POLICY_INPUT context 320 and passes the INPUT processing rule context 306 to the SLD processing rules 322 that are processed after the SLA processing rules. Thus, the double slash characters (e.g., “//”) represent the flow interruption and the message input being reset back to the INPUT processing rule context 306. The double slash characters can be seen within FIG. 3 between policy subjects as well (e.g., the SLD endpoint call action 302 and the SLD service call action 304).

As such, the filter-mode policy enforcement flow 300 that supports the “filter” enforcement mode of operation creates an input context and distributes that input context independently to each processing rule that is used to operate upon and enforce a policy against the message. Accordingly, the filter-mode policy enforcement flow 300 may be utilized to allow all processing rules to independently process messages/objects without modification of the input stream by prior processing rules.

FIG. 4 is a diagram of an example of an implementation of an enforce-mode policy enforcement flow 400 for policy assertion linking to processing rule contexts for policy enforcement using an “enforce” enforcement mode of operation. Again, for purposes of the present examples, it is assumed that SLA enforcement precedes SLD enforcement against objects (e.g., messages). As can be seen from FIG. 4, the same processing assertions from FIG. 3 that are associated with policies to be enforced are represented. As such, the SLD endpoint call action 302 for SLA policy enforcement is again shown to precede the SLD service call action 304 for SLD policy enforcement. The “INPUT” processing rule context 306 is again provided as initial input. However, as described in more detail below, the “INPUT” processing rule context 306 is not provided to all processing rules within the enforce-mode policy enforcement flow 400. The SLA-check action 308, the for-each SLA matched action 310, and the call SLA rule action 312 are again illustrated and operate on messages, as described above, subject to input context variations as described below based upon the enforce mode of operation. The SLA processing rule 314, the SLA processing rule 316, and the SLA processing rule 318, along with the SLD processing rules 322, are illustrated and operate as described in association with FIG. 3.

With the enforcement mode set to “enforce,” any changes made to the message in the flow may be provided as input and reflected in subsequent processing rules. As shown in FIG. 4, the policy framework 216 inserts two enforce-mode transformation actions. Regarding the first enforce-mode transformation action, an input identity transform action 402 stores the raw incoming message (INPUT) within a common context (as in FIG. 3, the same reference designator “320” of the SLA_POLICY_INPUT context 320 is utilized to reduce complexity of the present description). The SLA_POLICY_INPUT context 320 may then be used as the input context by the SLA-check action 308 and the for-each SLA matched action 310 to call the matching SLA processing rules 314 through 318.

The matching SLA processing rules 314 through 318 themselves specify their input and output contexts as the shared SLA_POLICY_INPUT context 320. As such, any changes made during processing within the respective processing rule will also be passed on to the next matching SLA processing rule to be called. This sequential context modification and processing is logically represented by the sequential output-to-input connectivity of the shared SLA_POLICY_INPUT context 320 among the SLA processing rule 314, the SLA processing rule 316, and the SLA processing rule 318 within FIG. 4.

Regarding the second enforce-mode transformation action, when all the matching SLA processing rules 314 through 318 have been enforced, the SLA_POLICY_INPUT context 320 is stored back to the INPUT processing rule context 306 by an output identity transform action 404. As such, the common context (SLA_POLICY_INPUT context 320) as modified by the SLA processing rules is stored back into the original INPUT processing rule context 306 after processing is completed by the represented processing rules.

Within this example, the SLD actions are enforced with the newly modified INPUT processing rule context 306 as the input. The policy framework 216 connects the policy subject policies with a PIPE action context 406 that directly connects the output of one processing action to the next processing action.

As such, the enforce-mode policy enforcement flow 400 provides input context transformation and distribution to processing rules. The processing rules take as input the message as modified by previous processing rules. The accumulated enforcement changes to the message are passed to subsequent processing rules, and the modified message is transformed back to the original input context for subsequent processing.

As such, the policy framework 216 provides dynamic policy enforcement to allow processing rules from different policy domains to be enforced on individual messages as the message flows through the proxy processing provided by a PEP. Accordingly, policy implementation and enforcement across different policy domains may be improved by use of the present technology.

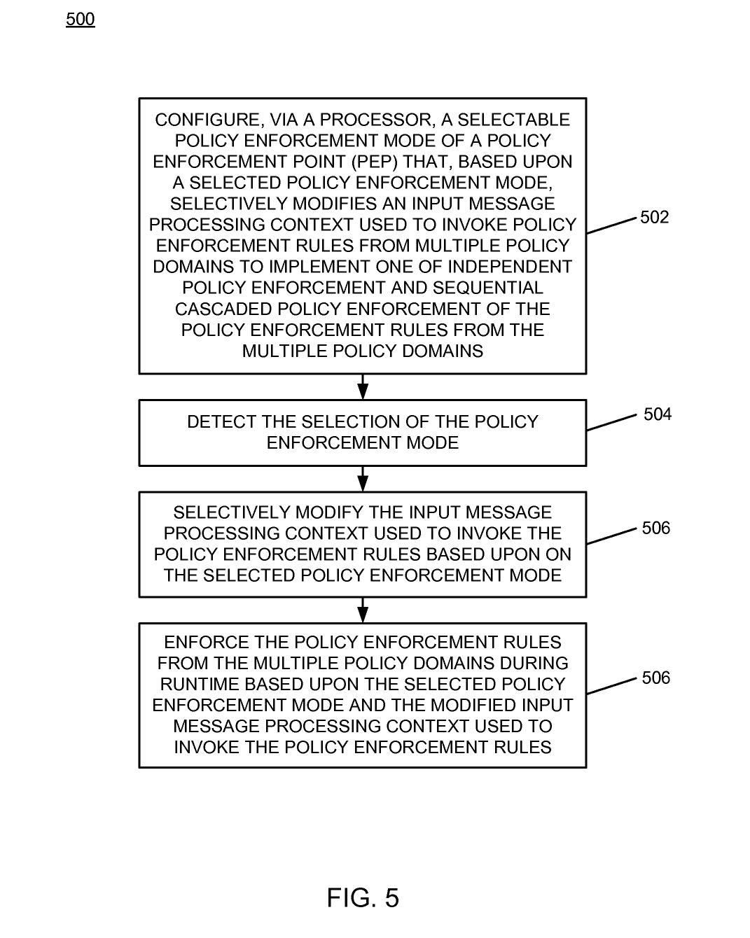

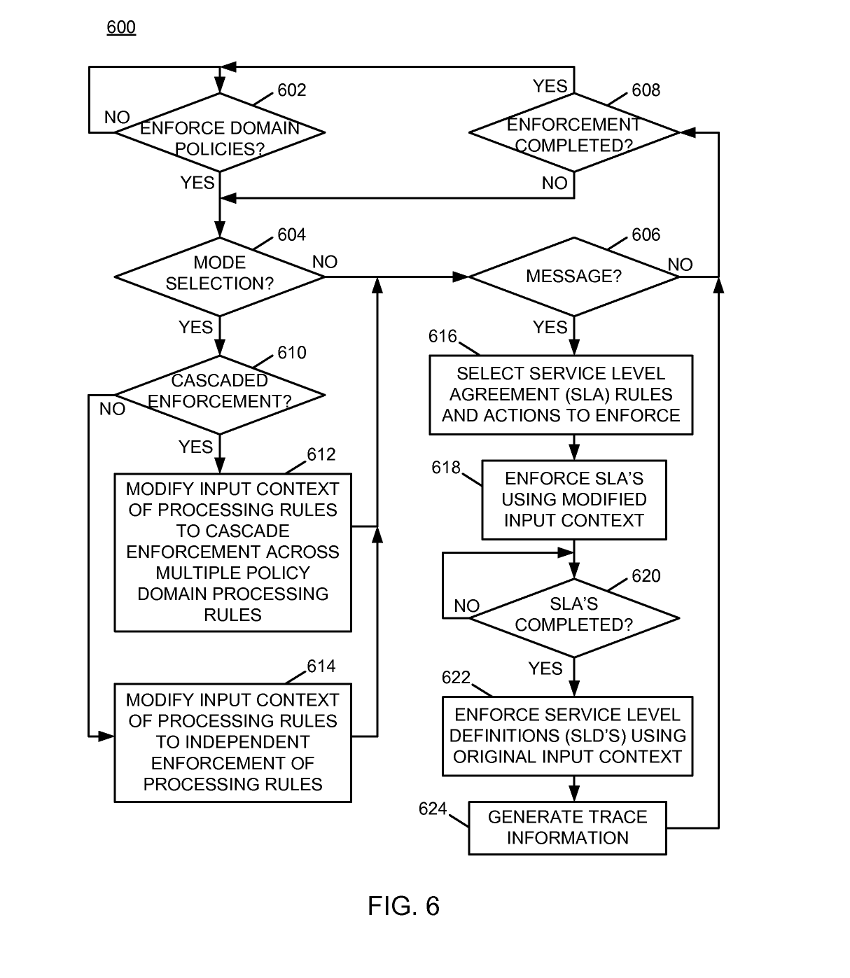

FIG. 5 through FIG. 6 described below represent example processes that may be executed by devices, such as the core processing module 200, to perform the policy assertion linking to processing rule contexts for policy enforcement associated with the present subject matter. Many other variations on the example processes are possible and all are considered within the scope of the present subject matter. The example processes may be performed by modules, such as the policy framework 216 and/or executed by the CPU 202, associated with such devices. It should be noted that time out procedures and other error control procedures are not illustrated within the example processes described below for ease of illustration purposes. However, it is understood that all such procedures are considered to be within the scope of the present subject matter. Further, the described processes may be combined, sequences of the processing described may be changed, and additional processing may be added or removed without departure from the scope of the present subject matter.

FIG. 5 is a flow chart of an example of an implementation of a process 500 for policy assertion linking to processing rule contexts for policy enforcement. At block 502, the process 500 configures, via a processor, a selectable policy enforcement mode of a policy enforcement point (PEP) that, based upon a selected policy enforcement mode, selectively modifies an input message processing context used to invoke policy enforcement rules from multiple policy domains to implement one of independent policy enforcement and sequential cascaded policy enforcement of the policy enforcement rules from the multiple policy domains. At block 504, the process 500 detects the selection of the policy enforcement mode. At block 506, the process 500 selectively modifies the input message processing context used to invoke the policy enforcement rules based upon on the selected policy enforcement mode. At block 508, the process 500 enforces the policy enforcement rules from the multiple policy domains during runtime based upon the selected policy enforcement mode and the modified input message processing context used to invoke the policy enforcement rules.

FIG. 6 is a flow chart of an example of an implementation of a process 600 for policy assertion linking to processing rule contexts for policy enforcement. At decision point 602, the process 600 makes a determination as to whether a request to enforce domain policies has been detected, such as by initialization of an attachment point, administrative activation of policy enforcement, or other event. As described above, the present technology facilitates enforcement of multiple policy domains at a single service/attachment point on a policy enforcement point (PEP). As such, the process 600 may be executed in association with one or more PEPs within a policy enforcement platform.

In response to determining at decision point 602 that a request to enforce domain policies has been detected, the process 600 begins higher-level iterative processing. The higher-level decision points will be described first, followed by description of processing responsive to affirmative decisions at the respective decision points.

At decision point 604, the process 600 makes a determination as to whether a selection of a selectable policy enforcement mode has been detected, such as for example to implement one of independent policy enforcement (e.g., filter mode) and sequential cascaded policy enforcement (e.g., enforce mode, multiple domain enforcement) of the policy enforcement rules from the multiple policy domains. It should be noted that in response to a negative determination at decision point 604, a default configuration/selection context or a last selected policy enforcement mode context may be utilized until a new selection of a selectable policy enforcement mode has been detected. Further, a default configuration/selection context may be selected as appropriate for a given implementation, such as for example one of the filter or enforce modes described above.

In response to determining that a selection of a selectable policy enforcement mode has not been detected at decision point 604, the process 600 makes a determination at decision point 606 as to whether a message has been received to process via one or more policy domains. In response to determining that a message has not been received to process via one or more policy domains at decision point 606, the process 600 makes a determination at decision point 608 as to whether enforcement processing has been completed. In response to determining that enforcement processing has not been completed at decision point 608, the process 600 returns to decision point 604 and iterates as described above.

Returning to the description of decision point 604, in response to determining that a selection of a selectable policy enforcement mode has been detected, the process 600 makes a determination at decision point 610 as to whether the selected policy enforcement mode represents a cascaded multiple domain policy enforcement mode selection (e.g., a selection of the enforce mode). In response to determining that the selected policy enforcement mode represents a cascaded multiple domain policy enforcement mode selection, the process 600 modifies the input context of processing rules to cascade enforcement across multiple policy domain processing rules at block 612 to configure the enforce mode of message processing. Alternatively, in response to determining that the selected policy enforcement mode does not represent a cascaded multiple domain policy enforcement mode selection, the process 600 modifies the input context of processing rules to independent enforcement of processing rules at block 614 to configure the filter mode of message processing.

In response to modification of the input context based upon the policy enforcement mode at one of block 612 and block 614, the process 600 returns to decision point 606. At decision point 606, in response to determining that a message has been received to process via one or more policy domains, the process 600 selects service level agreement (SLA) processing rules and processing actions to enforce at block 616. This processing to select SLAs for enforcement may be implemented, for example, as described above in association with the SLA-check action 308 of FIG. 3 and FIG. 4. Additionally, selection of SLAs may be based upon credentials within the message. As such, runtime determination of SLAs to be enforced may be based upon message content.

At block 618, the process 600 enforces the selected SLAs using the modified input context as configured/selected based upon the selected or default policy enforcement mode (e.g., filter or enforce modes). As also described above, for the filter mode of policy enforcement, each SLA is provided with an unmodified version of the message for processing to implement independent processing of the message among each selected SLA to be enforced. Alternatively, for the enforce mode of policy enforcement, the message may be sequentially processed by multiple SLAs with the processed message output of any SLA being propagated/cascaded to the next SLA for processing until SLA processing has been completed.

At decision point 620, the process 600 makes a determination as to whether SLA processing has been completed. In response to determining that SLA processing has been completed, the process 600 enforces service level definition(s) (SLDs) using the original input context (e.g., an unmodified input message) at block 622. As such, SLAs may be processed based upon the selected policy enforcement mode, and SLDs may be processed independently of the selected policy enforcement mode.

At block 624, the process 600 generates trace (e.g., enforcement rule logging) information. The trace and logging information generated may be utilized to evaluate the enforcement actions performed based upon the selected policy enforcement mode. The process 600 returns to decision point 608 and iterates as described above. In response to determining that enforcement processing has been completed at decision point 608, the process 600 returns to decision point 602 and iterates as described above.

As such, the process 600 implements selectable policy enforcement by providing for selection of a policy enforcement mode that selects between independent policy enforcement and multiple domain (cascaded) policy enforcement for SLAs. SLDs may be enforced using the original unmodified message. Trace and logging may be captured to document the selected policy enforcement modes as messages are processed.

As described above in association with FIG. 1 through FIG. 6, the example systems and processes provide policy assertion linking to processing rule contexts for policy enforcement. Many other variations and additional activities associated with policy assertion linking to processing rule contexts for policy enforcement are possible and all are considered within the scope of the present subject matter.

Those skilled in the art will recognize, upon consideration of the above teachings, that certain of the above examples are based upon use of a programmed processor, such as the CPU 202. However, the invention is not limited to such example embodiments, since other embodiments could be implemented using hardware component equivalents such as special purpose hardware and/or dedicated processors. Similarly, general purpose computers, microprocessor based computers, micro-controllers, optical computers, analog computers, dedicated processors, application specific circuits and/or dedicated hard wired logic may be used to construct alternative equivalent embodiments.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as JAVA, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention have been described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable storage medium that can direct a computer or other programmable data processing apparatus to function in a particular manner, such that the instructions stored in the computer-readable storage medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modems and Ethernet cards are just a few of the currently available types of network adapters.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method, comprising:
configuring, via a processor, a selectable policy enforcement mode of a policy enforcement point (PEP) that, based upon a selected policy enforcement mode, selectively modifies an input message processing context used to invoke policy enforcement rules from multiple policy domains to implement one of independent policy enforcement and sequential cascaded policy enforcement of the policy enforcement rules from the multiple policy domains;
detecting the selection of the policy enforcement mode;
selectively modifying the input message processing context used to invoke the policy enforcement rules based upon on the selected policy enforcement mode; and
enforcing the policy enforcement rules from the multiple policy domains during runtime based upon the selected policy enforcement mode and the modified input message processing context used to invoke the policy enforcement rules.

2. The method of claim 1, where a first selectable policy enforcement mode comprises a filter policy enforcement mode that passes a same input context stream to each of a plurality of policy enforcement rules to implement the independent policy enforcement of the policy enforcement rules from the multiple policy domains.

3. The method of claim 2, where a second selectable policy enforcement mode comprises an enforce policy enforcement mode that sequentially provides a processed output context stream from at least one of the policy enforcement rules to a subsequent policy enforcement rule to implement the sequential cascaded policy enforcement of the policy enforcement rules from the multiple policy domains.

4. The method of claim 1, where each policy enforcement rule comprises policy assertions that process messages based upon the selected input message processing context, and where enforcing the policy enforcement rules from the multiple policy domains during the runtime based upon the selected policy enforcement mode and the modified input message processing context used to invoke the policy enforcement rules comprises invoking each policy assertion to process messages based upon the selected input message processing context.

5. The method of claim 1, where the policy enforcement rules comprise at least one service level agreement (SLA) policy enforcement rule and the at least one SLA policy enforcement rule one of accepts and rejects a message based upon whether the message is compliant with constraints established within a policy enforcement domain associated with the at least one SLA policy enforcement rule.

6. The method of claim 1, where service level agreement (SLA) policy enforcement rules are processed based upon the selected policy enforcement mode, and service level definition (SLD) policy enforcement rules are processed using an original input context.

7. The method of claim 1, further comprising generating a trace of policy rule enforcement actions to document processing of the enforced policy enforcement rules from the multiple policy domains during runtime based upon the selected policy enforcement mode and the modified input message processing context used to invoke the policy enforcement rules.

8. A system, comprising:
a memory; and
a processor programmed to:
configure, within the memory, a selectable policy enforcement mode of a policy enforcement point (PEP) that, based upon a selected policy enforcement mode, selectively modifies an input message processing context used to invoke policy enforcement rules from multiple policy domains to implement one of independent policy enforcement and sequential cascaded policy enforcement of the policy enforcement rules from the multiple policy domains;
detect the selection of the policy enforcement mode;
selectively modify the input message processing context used to invoke the policy enforcement rules based upon on the selected policy enforcement mode; and
enforce the policy enforcement rules from the multiple policy domains during runtime based upon the selected policy enforcement mode and the modified input message processing context used to invoke the policy enforcement rules.

9. The system of claim 8, where a first selectable policy enforcement mode comprises a filter policy enforcement mode that passes a same input context stream to each of a plurality of policy enforcement rules to implement the independent policy enforcement of the policy enforcement rules from the multiple policy domains.

10. The system of claim 9, where a second selectable policy enforcement mode comprises an enforce policy enforcement mode that sequentially provides a processed output context stream from at least one of the policy enforcement rules to a subsequent policy enforcement rule to implement the sequential cascaded policy enforcement of the policy enforcement rules from the multiple policy domains.

11. The system of claim 8, where each policy enforcement rule comprises policy assertions that process messages based upon the selected input message processing context, and where, in being programmed to enforce the policy enforcement rules from the multiple policy domains during the runtime based upon the selected policy enforcement mode and the modified input message processing context used to invoke the policy enforcement rules, the processor is programmed to invoke each policy assertion to process messages based upon the selected input message processing context.

12. The system of claim 8, where the policy enforcement rules comprise at least one service level agreement (SLA) policy enforcement rule and the at least one SLA policy enforcement rule one of accepts and rejects a message based upon whether the message is compliant with constraints established within a policy enforcement domain associated with the at least one SLA policy enforcement rule.

13. The system of claim 8, where service level agreement (SLA) policy enforcement rules are processed based upon the selected policy enforcement mode, and service level definition (SLD) policy enforcement rules are processed using an original input context.

14. A computer program product, comprising:
a computer readable storage medium having computer readable program code embodied therewith, where the computer readable program code when executed on a computer causes the computer to:
configure a selectable policy enforcement mode of a policy enforcement point (PEP) that, based upon a selected policy enforcement mode, selectively modifies an input message processing context used to invoke policy enforcement rules from multiple policy domains to implement one of independent policy enforcement and sequential cascaded policy enforcement of the policy enforcement rules from the multiple policy domains;
detect the selection of the policy enforcement mode;
selectively modify the input message processing context used to invoke the policy enforcement rules based upon on the selected policy enforcement mode; and
enforce the policy enforcement rules from the multiple policy domains during runtime based upon the selected policy enforcement mode and the modified input message processing context used to invoke the policy enforcement rules.

15. The computer program product of claim 14, where a first selectable policy enforcement mode comprises a filter policy enforcement mode that passes a same input context stream to each of a plurality of policy enforcement rules to implement the independent policy enforcement of the policy enforcement rules from the multiple policy domains.

16. The computer program product of claim 15, where a second selectable policy enforcement mode comprises an enforce policy enforcement mode that sequentially provides a processed output context stream from at least one of the policy enforcement rules to a subsequent policy enforcement rule to implement the sequential cascaded policy enforcement of the policy enforcement rules from the multiple policy domains.

17. The computer program product of claim 14, where each policy enforcement rule comprises policy assertions that process messages based upon the selected input message processing context, and where in causing the computer to enforce the policy enforcement rules from the multiple policy domains during the runtime based upon the selected policy enforcement mode and the modified input message processing context used to invoke the policy enforcement rules, the computer readable program code when executed on the computer causes the computer to invoke each policy assertion to process messages based upon the selected input message processing context.

18. The computer program product of claim 14, where the policy enforcement rules comprise at least one service level agreement (SLA) policy enforcement rule and the at least one SLA policy enforcement rule one of accepts and rejects a message based upon whether the message is compliant with constraints established within a policy enforcement domain associated with the at least one SLA policy enforcement rule.

19. The computer program product of claim 14, where service level agreement (SLA) policy enforcement rules are processed based upon the selected policy enforcement mode, and service level definition (SLD) policy enforcement rules are processed using an original input context.

20. The computer program product of claim 14, where the computer readable program code when executed on the computer further causes the computer to generate a trace of policy rule enforcement actions to document processing of the enforced policy enforcement rules from the multiple policy domains during runtime based upon the selected policy enforcement mode and the modified input message processing context used to invoke the policy enforcement rules.
